(19) United States
(12) Patent Application Publication
(10) Pub. No.: US 2022/0282803 A1
(43) Pub. Date: Sep. 8, 2022

(54) EXPANSION STRUT CLAMP

(71) Applicant: GLENN CREWL, HEMET, CA (US)

(72) Inventor: GLENN CREWL, HEMET, CA (US)

(21) Appl. No.: 17/189,280

(22) Filed: Mar. 2, 2021

(51) Int. Cl. F16L 3/10; F16L 3/24

(52) U.S. Cl. CPC F16L 3/1033; F16L 3/24

(57) ABSTRACT

A method and apparatus for mounting an additional conduit to the support for an existing conduit carried by an existing a strut clamp secured to an existing strut. A connection by an extension strut clamp and the additional conduit makes possible securely mounting the additional conduit when the usual engagement surface of the strut is already fully occupied. This is achieved without imposing any forces or load on any existing conduit.

### TECHNICAL FIELD

The present invention is generally directed to electrical wiring for residential and commercial buildings. More particularly, the present invention is primarily directed to the mounting for electrical conduits. Although this application is focused on electrical conduits, it will be clear that it has application to other conduits.

Even more particularly, the present invention is directed to an expansion strut clamp that allows installation to an existing strut clamp that is typically engaged with both a first conduit and a first strut. That said, the present invention also has application to installing two conduits respectively secured to a strut that only has space for one conventional strut clamp by sequentially installing a conventional strut clamp in addition to one strut clamp in accordance with the present invention.

### BACKGROUND OF THE INVENTION

The layout of conduits, particularly in large buildings can be very complex. Examples of very large arrays of conduits typically arrayed with axial parts of the conduits disposed with the axes of the conduits in coplanar relationship. Typically, a strut is mounted to extend in perpendicular relationship to the conduits at spaced intervals along the axial extent of the conduits. A strut clamp joins each conduit to a strut.

Examples of such arrays appear at:

http://learelectric.org/wp-content/uploads/2016/10/Condit-rack.jpg

https://www.reddit.com/r/conduitporn/comments/9ot4le/which_way_to_the_elevation_change/

The definition of strut or strut channel appears at: https://en.wikipedia.org/wiki/Strut_channel

Examples of strut clamps are displayed, for example, by searching Amazon.com for “Unistrut clamps.”

The number of strut clamps that can engage a given strut is a finite number because the strut has a finite length and each strut clamp has a finite length. If all struts, close to a given location where it is desired to install a conduit, have all available space along the axial extent of each strut are fully utilized/occupied, installation of each new conduit conventionally requires installation of an additional strut carrying the new conduit. Even worse, a new strut and strut clamp may have to installed at successive axial parts of the new conduit because other struts disposed at successive axial parts are also fully utilized/occupied!

Building codes do not allow the attachment of any load to any existing conduit. Thus, for example, A new conduit cannot be supported by a previously installed conduit.

It is an object of the present invention to provide a support for a new conduit that does not rely on support from an existing conduit and does not require the installation of additional struts along substantially the entire axial extent of, for example, one new conduit as would be the case if the existing struts were already fully occupied, the present invention eliminates the need for installation of a plurality of struts located at axially spaced points along substantially the axial extent of the new conduit. Thus, the amount of expense, work and time saving may be enormous.

Because the prior apparatus and method result in enormous waste of expense, work and time, it is therefore seen that there exists a need in the art to overcome the deficiencies and limitations described herein and above.

### SUMMARY OF THE INVENTION

The shortcomings of the prior art are overcome and additional advantages are provided through a method for mounting a conduit to an existing support for at least one conduit having a strut clamp secured to the one conduit and a strut where the existing strut clamp comprises first and second existing elongated plates secured with an existing machine screw.

In another aspect the method includes the steps of detaching the existing machine screw and nut; providing third and fourth elongated plates each having a cylindrical section shaped midsection and planar flanges at each axial extremity; positioning the third and fourth elongated plates in opposed relationship with the first and second axial extremities of the third and fourth elongated plates in registered relationship; securing one axial extremity of each of the first and second plates as well as one axial extremity of the third and fourth plates with the existing machine screw and nut; positioning another conduit intermediate the cylindrical section shaped midsections of said third and fourth plates and securing the other axial extremity of the third and fourth plates with a machine screw whereby a conduit is mounted from a strut without occupying any additional space along the axial extent of the strut and without imposing any load on any conduit.

The method may include a step of providing first and second elongated plates each having a cylindrical section shaped midsection and planar flanges at each axial extremity that further includes providing a lip at one axial extremity dimensioned and configured to abut the existing strut clamp when installed.

Apparatus in accordance with the present invention is intended to support a conduit on an existing mounting for a previously mounted conduit. Typically, the existing conduit is mounted with an existing strut clamp having first and second plates secured with a machine screw on an existing elongated strut. The problem occurs when there is no additional space on the strut. The apparatus in accordance with one form of the present invention enables supporting the additional conduit without the need to erect an additional strut. One form includes second and third elongated plates each having the same length, a cylindrical section shaped midsection and planar flanges at first and second axial extremities of each plate. Each flange may define an opening therein.

Openings in respective first and second axial extremities of the second and third elongated plates when said second and third elongated plates are disposed in opposed relationship may be registered.

Some embodiments may include a lip at one axial extremity dimensioned and configured for side abutting engagement with an existing strut clamp to provide greater stability.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a side view of part of a structural I-beam to which is attached a web strut. The attachment is achieved with two C-clamps. Three prior art strut clamps are shown attached to a strut. One expansion clamp in accordance with the present invention is shown attached to one of the prior art strut clamps.

FIG. 2 is an isometric view of one embodiment of the clamp in accordance with one embodiment of the present invention.

FIG. 3 is an isometric view of the same clamp engaged with a strut.

FIG. 4 is a more detailed view of an expansion strut clamp in accordance with the present invention.

### DETAILED DESCRIPTION

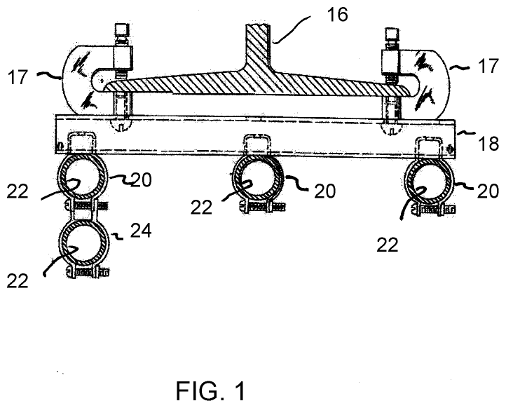

FIG. 1 is a side view of part of a structural I-beam 16 to which is attached a strut 18. The attachment is achieved with two C-clamps 17. Three prior art strut clamps 20 are shown attached to the strut 18. Each strut clamp 20 supports a conduit 22.

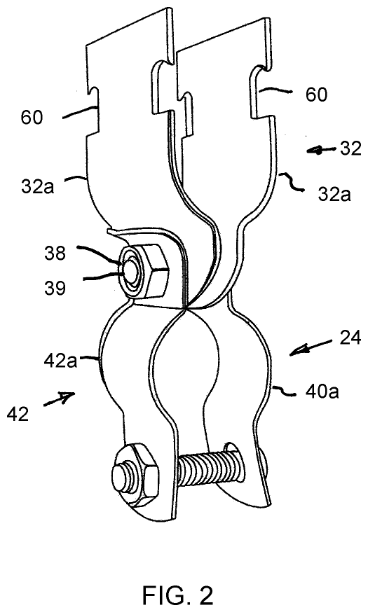

To the above described assembly is attached an expansion clamp 24 shown in FIG. 1 as well as FIGS. 2-4. The expansion clamp supports another conduit 22. Although, all the conduits are all shown as having identical sizes, it will be understood that such uniformity is not a requisite if the present invention. Thus, all conduits shown may, for example, have different diameters.

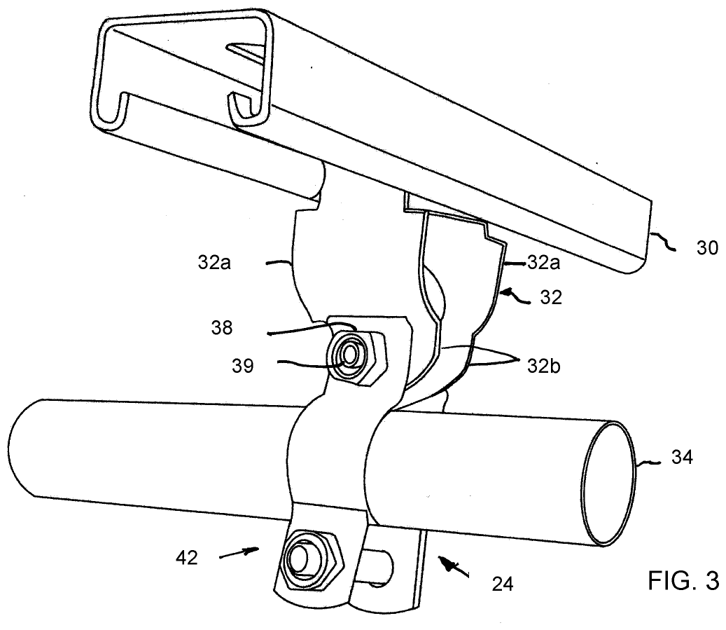

FIGS. 2 and 3 are more detailed views of an alternate prior art strut 30 cooperating with another prior art strut clamp 32 to which is attached an expansion strut clamp 24 in accordance with the present invention supporting a conduit 22 in accordance with the present invention. For convenience, the prior art strut clamp may be referred to herein as the base clamp 32. Ordinarily, the illustrated prior art base strut clamp 32 can also support a conduit 34. The omission of any conduit within strut clamp 32 will be understood to illustrate an embodiment of the present invention that not only does not impose any load on an original conduit, the illustrated embodiment does not even have another conduit carried in the base strut clamp. The illustrated embodiment functions without any conduit 34 in the base strut clamp 32. It will be understood that for some applications, it might be desirable to position the additional conduit at some greater distance from the adjacent original conduit.

The prior art base clamp 32 includes elongated plates having cylindrical section shaped midsections 32a from which an axial extremity flange 32b extends. A machine screw 34 cooperating with a nut 36 ordinarily secure the existing clamp 32 to a conduit. Engagement surfaces 60 on the prior art clamp 32 engage the strut 30.

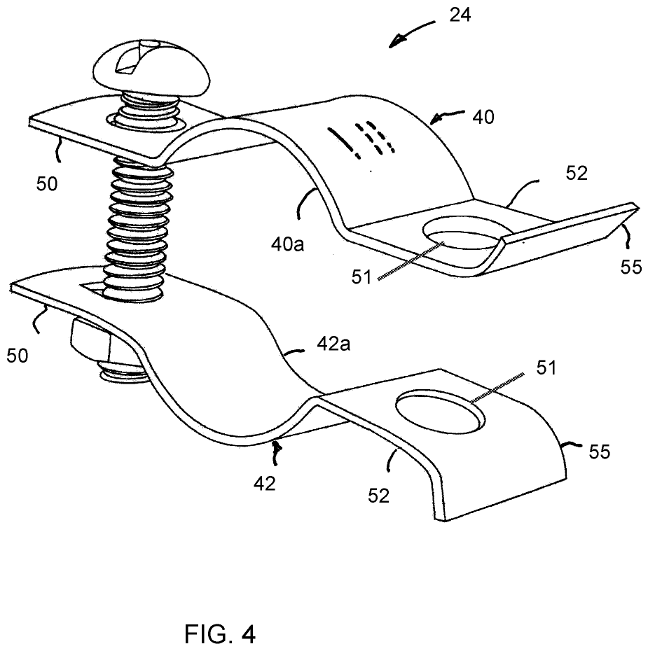

An embodiment of the expansion clamp that makes possible the enormous savings of time, expense and aggravation is shown in FIG. 4. The embodiment of the invention illustrated includes elongated first and second plates 40, 42. Typically, the plates are manufacture by a stamping operation. The elongated plates 40, 42 have respective cylindrical section shaped midsections 42a, 42b. The geometric axis of each cylindrical midsection 42a, 42b is perpendicular to the direction of elongation of each plate 40, 42. Each elongated plate 40, 42 includes a first planar flange 50 disposed at a first axial extremity thereof. Each elongated plate 40, 42 includes a second planar flange 52 disposed at a second axial extremity thereof. Each second planar flange 52 further includes a lip 55 extending obliquely from the second planar flange 52. Each lip 55 is dimensioned and configured to abut a cylindrical midsection 32a of the prior art base clamp 32. Thus, the lips 55 further stabilize the extension clamp with respect to the existing clamp 32

Thus, each plate 40, has along the axial extent thereof a first flange, a cylindrical section and a second flange. Each flange includes a hole 51 for insertion of a machine screw. The holes 51 in each respective ends of the plates 40, 42 are disposed in registered relationship. The FIG. 4 illustration shows one axial extremity having no machine screw. It will be understood that the flanges 52 at that axial extremity will be secured by the original machine screw 38 and nut 39 that originally held only the existing clamp 32.

The width of each plate is uniform in the illustrated embodiment.

Although the description herein focuses on the mounting of electrical conduit, it will be understood that the apparatus and methods described herein have application to the mounting and installation of any elongated cylindrical object including plumbing and sewer pipes.

As used herein, the use of the term “opposed” with respect to, for example the plates shown in FIG. 4 will be understood to mean that the cylindrical section parts are disposed as pictured with concave faces of the cylindrical sections facing each other.

Although, the description utilizes the term “machine screw” those skilled in the art will recognize that other fasteners with or without threads are known alternatives.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for mounting a conduit to the support for an existing support for at least one conduit having a strut clamp secured to the one conduit and a strut, the existing strut clamp comprising first and second existing elongated plates secured with an existing machine screw comprising:
the step of detaching the existing machine screw and nut;
providing third and fourth elongated plates each having a cylindrical section shaped midsection and planar flanges having a bore defined therein at each axial extremity;
positioning the third and fourth elongated plates in opposed relationship with the first and second axial extremities of the third and fourth elongated plates in registered relationship;
securing one axial extremity of each of the first and second plates as well as one axial extremity of the third and fourth plates with the existing machine screw and nut;
positioning a conduit intermediate the cylindrical section shaped midsections of the third and fourth plates; and
securing the other axial extremity of the third and fourth plates with a machine screw whereby a conduit is mounted from a strut without occupying any additional space along the axial extent of the strut and without imposing any load on any conduit.

2. The method as described in claim 1 wherein the step of providing first and second elongated plates each having a cylindrical section shaped midsection and planar flanges at each axial extremity that further includes providing a lip at one axial extremity dimensioned and configured to abut the existing strut clamp when installed.

3. Apparatus for mounting a conduit to an existing mounting for a previously mounted conduit that is mounted with an existing strut clamp clamped having first and second plates secured with a machine screw on an existing elongated strut without the need to erect an additional strut which comprises:
second and third elongated plates each having the same length, a cylindrical section shaped midsection and planar flanges at first and second axial extremities of each plate,
each flange defining an opening therein, openings in respective first and second axial extremities of said second and third elongated plates when said second and third elongated plates are disposed in opposed relationship being registered.

4. The apparatus as described in claim 4 further including a lip at one axial extremity dimensioned and configured for side abutting engagement with an existing strut clamp to provide greater stability.
